(19) United States
(12) Patent Application Publication
(10) Pub. No.: US 2017/0329288 A1
(43) Pub. Date: Nov. 16, 2017

(54) SMART DEVICE DETACHABLY EQUIPPED TO WATCH

(71) Applicant: VNI SOLUTION CO., LTD., Daejeon (KR)

(72) Inventor: Saeng Hyun CHO, Suwon-si, Gyeonggi-do (KR)

(73) Assignee: VNI SOLUTION CO., LTD., Daejeon (KR)

(21) Appl. No.: 15/523,100

(22) PCT Filed: Sep. 24, 2015
(86) PCT No.: PCT/KR2015/010101

§ 371 Date: Apr. 28, 2017

(30) Foreign Application Priority Data
Nov. 26, 2014 (KR) 10-2014-0166687

(51) Int. Cl. G04G 17/08; G04B 37/12; G04B 47/00; G04G 17/04

(52) U.S. Cl. CPC G04G 17/083; G04G 17/045; G04B 37/12; G04B 47/00

(57) ABSTRACT

Provided is a smart device that can be attached to, and detached from a watch. The smart device includes: a display for displaying information; a controller that controls the display and displays information; a storage medium unit that is controlled by the controller and in which data is stored; a wireless communication unit that is controlled by the controller and performs wireless communication; a power supply unit that supplies power to the display, the controller, the storage medium unit, and the wireless communication unit; and a housing in which the display, the controller, the storage medium unit, the wireless communication unit, and the power supply unit are installed, wherein the housing includes an attachment/detachment part where a time display unit is attached and detached so that the housing can be attached to, and detached from a watch.

### TECHNICAL FIELD

The present invention relates to a smart device, and more particularly, to a smart device detachably equipped to a wristwatch.

### BACKGROUND ART

A smart device indicates a product functions of which are not limited and may be modified or extended to a significant extent through an application program. Examples of the smart device include a smart phone, a smart pad, and a smart TV.

Particularly, a smart watch recently receives attention according to an increase in application field thereof, and is generally provided in the form of a wristwatch.

However, an existing smart watch has low usability and inconvenience in use thereof because the existing smart watch is a replacement of an existing analogue watch and thus is unable to be used together with the existing analogue watch.

### DISCLOSURE OF THE INVENTION

### Technical Problem

To solve the limitations, the present invention provides a smart device detachably equipped to a watch, which may be attached to, and detached from a watch in order to have a structure in which an existing watch may be used as it is.

### Technical Solution

Embodiments of the present invention suggest a smart device detached from and attached to a wristwatch, including a time display unit 10 configured to display time and a mounting part 20 coupled to both ends of the time display unit 10 such that the time display unit 10 is worn on the wrist of a user, the smart device including: a display 210 for displaying information; a controller 220 controlling the display 210 to display information; a storage medium unit 230 controlled by the controller 220, and in which data is stored; a wireless communication unit 240 controlled by the controller 220, and performs wireless communication; a power supply unit 250 supplying power to the display 210, the controller 220, the storage medium unit 230, and the wireless communication unit 240; and a housing 100 in which the display 210, the controller 220, the storage medium unit 230, the wireless communication unit 240, and the power supply unit 250 are installed, wherein the housing 100 includes an attachment/detachment part 110 attached to, and detached from the time display unit 10.

In some embodiments, the attachment/detachment part 110 may include an opening 111 formed in the housing 100 such that the time display unit 10 is inserted through the opening 111 in a perpendicular direction to an upper surface of the time display unit 10 to be upwardly exposed.

In some embodiments, the display 210 may be located on the attachment/detachment part 110 which is coupled to the time display unit 10.

In some embodiments, the housing 100 may be integrally formed with the attachment/detachment part 110.

In some embodiments, the housing 100 may include a cover unit 140 covering the time display unit 10.

In some embodiments, the cover unit 140 may be formed transparently such that the time display unit 10 is exposed to the outside, and the display 210 may be installed on an upper surface of the cover unit 140.

In some embodiments, the housing 100 may be integrally formed with the mounting part 20.

### Advantageous Effects

A smart device detachably equipped to a wristwatch according to the present invention can be attached to, and detached from a wristwatch in order to have a structure in which an existing watch can be used as it is, and may additionally have smart functions while using the existing watch, and is thus convenient in use.

### BRIEF DESCRIPTION OF THE DRAWINGS

FIG. 1 is a plane view showing a smart device detachably equipped to a watch according to embodiment 1 of the present invention;

FIGS. 2A and 2B are, respectively, a cross-sectional view of FIG. 1 viewed in II-II direction. The smart device is attached in FIG. 2A and detached in FIG. 2B;

FIG. 3 is a block diagram showing a configuration of the smart device illustrated in FIG. 1;

FIG. 4A is a plane view and FIGS. 4B and 4C are respectively a cross-sectional view. FIGS. 4A to 4C respectively show a smart device detachably equipped to a watch according to embodiment 2 of the present invention. The smart device is attached in FIG. 4B and detached in FIG. 4C;

FIGS. 5A and 5B are a plane view and a cross-sectional view respectively showing a smart device detachably equipped to a watch according to embodiment 3 of the present invention;

FIGS. 6A and 6B are a plane view and a cross-sectional view respectively showing a smart device detachably equipped to a watch according to embodiment 4 of the present invention; and

FIGS. 7A and 7B are a plane view and a cross-sectional view respectively showing a smart device detachably equipped to a watch according to embodiment 5 of the present invention.

### MODE FOR CARRYING OUT THE INVENTION

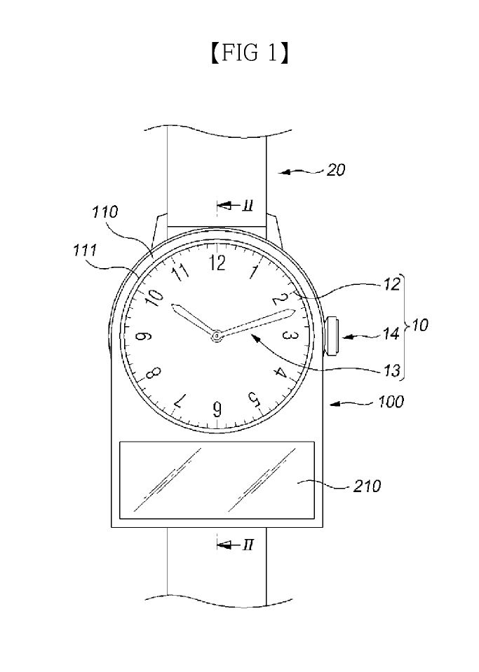

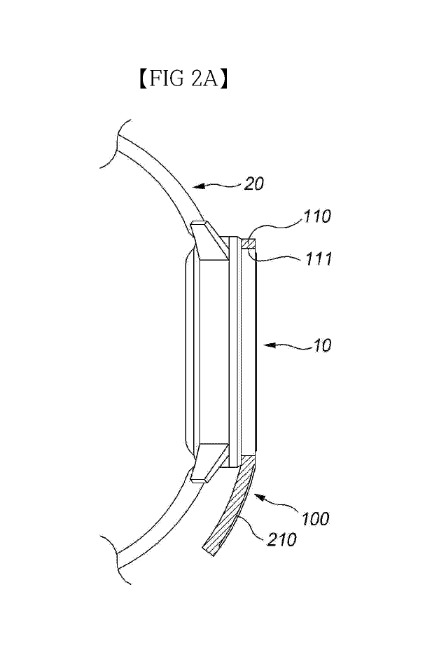

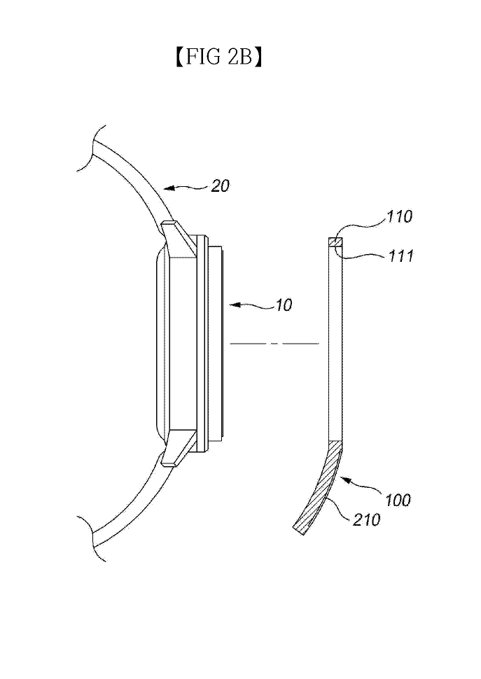

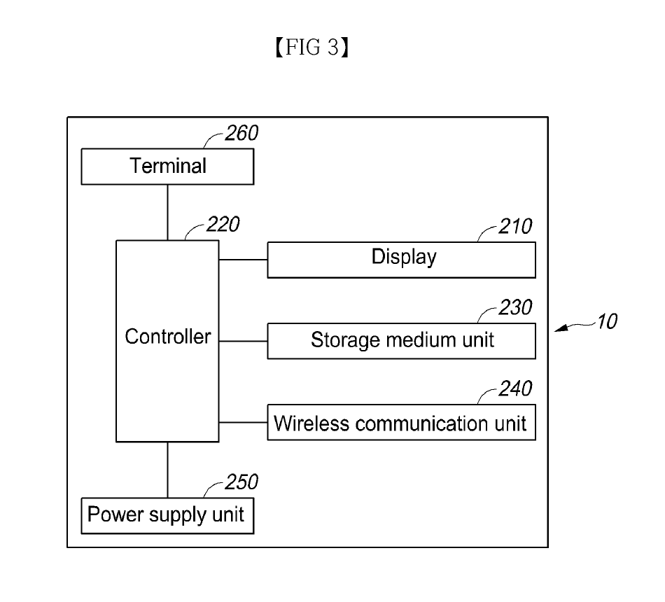

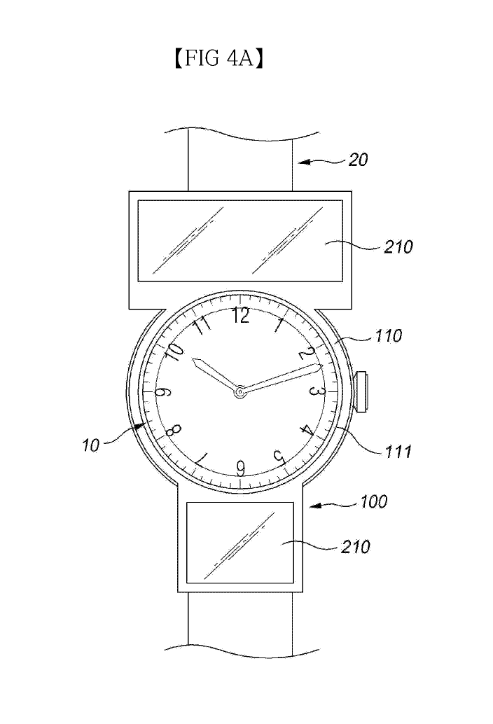

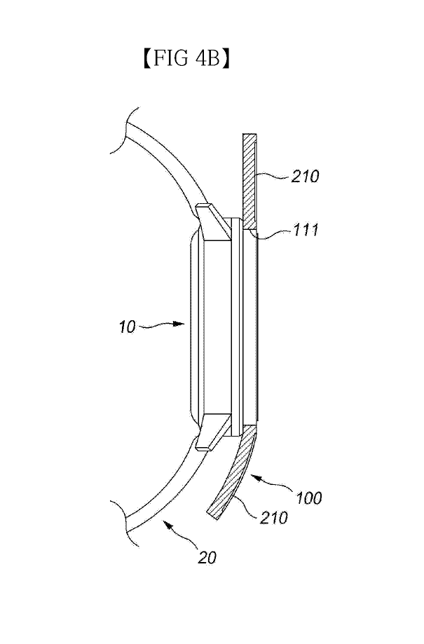

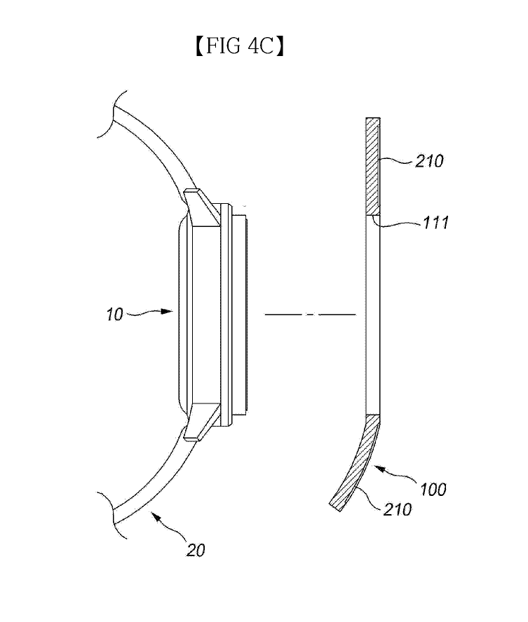

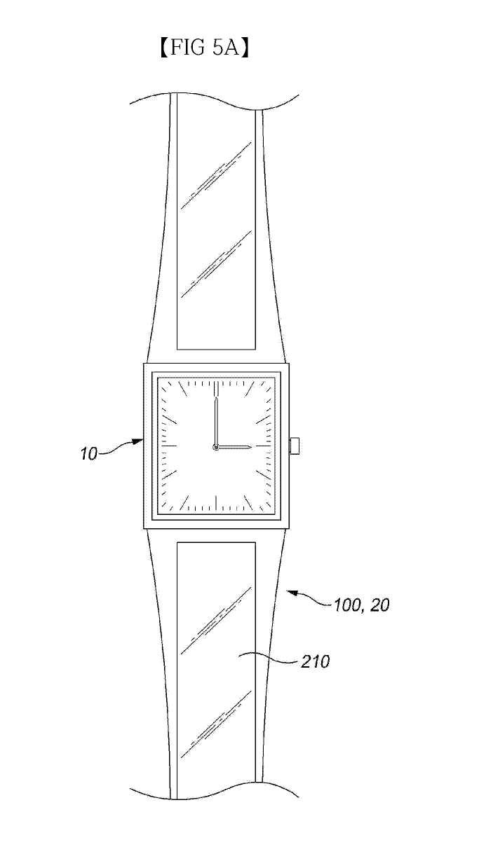

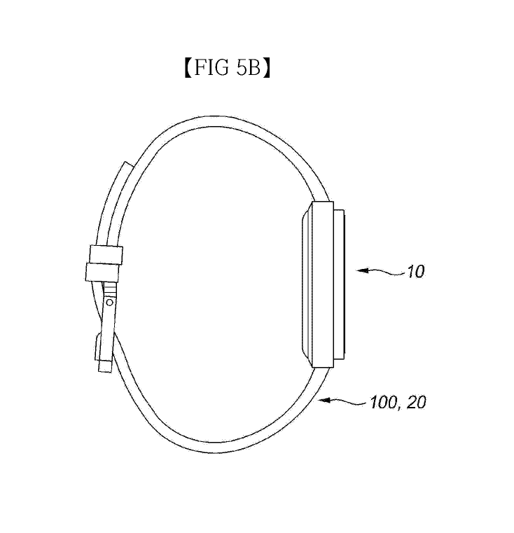

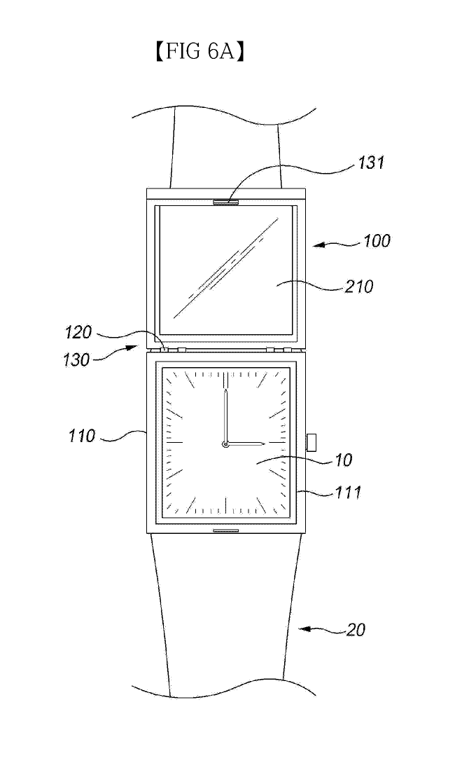

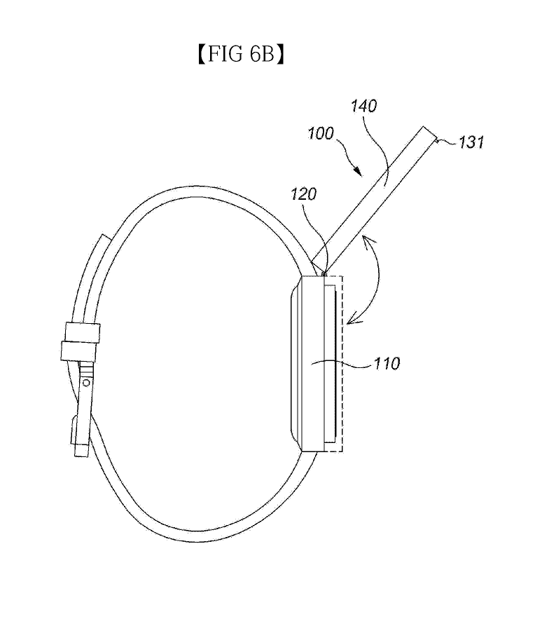

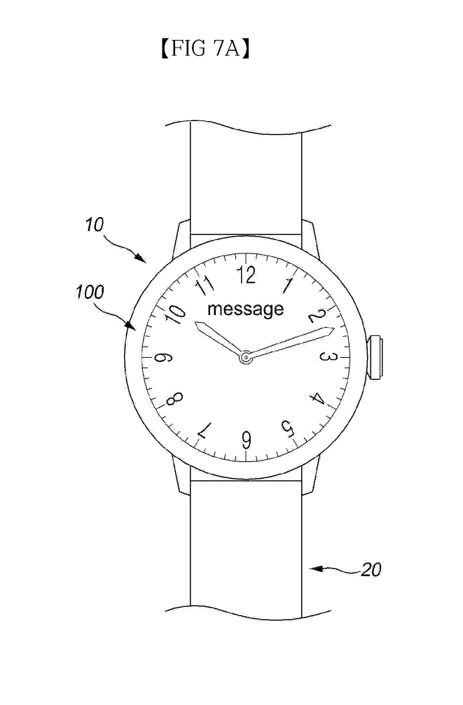

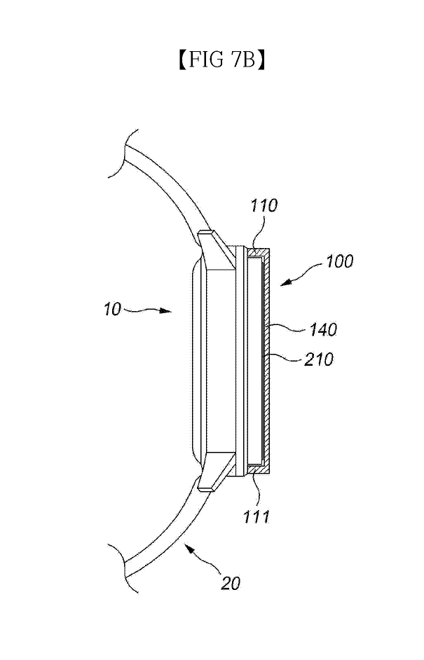

Hereinafter, embodiments of the present invention will be described with reference to the accompanied drawings. FIG. 1 is a plane view showing a smart device detachably equipped to a watch according to embodiment 1 of the present invention; FIG. 2A is a cross-sectional view of FIG. 1 viewed in II-II direction; FIG. 3 is a block diagram showing a configuration of the smart device illustrated in FIG. 1; FIGS. 4A and 4B are a plane view and a cross-sectional view respectively showing a smart device detachably equipped to a watch according to embodiment 2 of the present invention; FIGS. 5A and 5B are a plane view and a cross-sectional view respectively showing a smart device detachably equipped to a watch according to embodiment 3 of the present invention; FIGS. 6A and 6B are a plane view and a cross-sectional view respectively showing a smart device detachably equipped to a watch according to embodiment 4 of the present invention; and FIGS. 7A and 7B are a plane view and a cross-sectional view respectively showing a smart device detachably equipped to a watch according to embodiment 5 of the present invention.

As shown in FIGS. 1 to 7B, the smart device detachably equipped to a watch according to the present invention is a smart device detachably equipped to a wristwatch, which includes a time display unit 10, and a mounting part 20 coupled to both ends of the time display unit 10 such that the time display unit 10 is worn on the wrist of a user.

The wristwatch is a wristwatch including a time display unit 10, and a mounting part 20 which is coupled to both ends of the time display unit 10 such that the time display unit 10 is worn on the wrist of a user, and the wristwatch may be an analogue wristwatch, a digital wristwatch in which time etc. is displayed as numbers, and the like.

The time display unit 10, a core of the wristwatch, is a component to display time, and may be variously configured by having an analogue panel provided with an indicator 13 such as an hour hand and a minute hand, display gradations 12, and a manipulation dial 14, or a digital panel in which time is displayed as numbers.

The mounting part 20 is a component enabling the time display unit 10 to be worn on the wrist of a user, and may have various structures such as a chain structure or a belt structure.

The wristwatch may be any watch which may be classified as a watch wearable on the wrist of a user, excluding an existing smart watch.

The smart device includes: a display 210 that is detachably attached to a wristwatch, and displays information; a control unit 220 that controls the display 210, and performs information display; a storage medium unit 230 that is controlled by the control unit 220, and in which data is stored; a wireless communication unit 240 that is controlled by the control unit 220, and performs wireless communication; a power supply unit 250 supplying power to the display 210, the control unit 220, the storage medium unit 230, and the wireless communication unit 240; and a housing 100 in which the display 210, the controller 220, the storage medium unit 230, the wireless communication unit 240, and the power supply unit 250 are installed.

The display 210 is a component that displays information composed of texts, symbols and images, etc.

The display 210 may be any configuration that has a screen for information display, such as a liquid crystal display (LCD) 210, and an organic light emitting diode (OLED) display 210.

The controller 220 is a component that controls the display 210, and performs information display, and may be variously constituted with a mobile CPU etc.

It is possible that the controller 220 controls all control targets such as the wireless communication unit 240, the storage medium unit 230, and the power supply unit 250 besides the display 210.

The storage medium unit 230 is a component in which data is stored, and is controlled by the controller 220, and may be any medium such as a flash rom and a flash ram in which digital data may be stored.

The data being stored in the storage medium 230 may be a program for operating the smart device, data to be displayed in the display 210 and the like.

The wireless communication unit 240 is a component that is controlled by the controller 220, and performs wireless communication.

The wireless communication unit 240 may include at least one or more wireless communication modules based on a wireless communication method such as Bluetooth, Wi-Fi (wireless fidelity), and long-term evolution (LTE).

The power supply unit 250 is a component that supplies power such that the display 210, the controller 220, the storage medium unit 230, and the wireless communication unit 240 may operate.

The power supply unit 250 may include a highly portable rechargeable battery such as a lightweight lithium-ion battery in consideration that the smart device is portable.

The power supply unit 250 may be connected to a terminal installed in the housing 100, which will be later described, for charging of the rechargeable battery.

The housing 100 is a component in which the display 210, the controller 220, the storage medium unit 230, the wireless communication unit 240, and the power supply unit 250 are installed.

The housing 100 may be available in variously structures for the convenience of installation of the display 210, the controller 220, the storage medium unit 230, the wireless communication unit 240, and the power supply unit 250, and, particularly based on a coupling structure with the time display unit 10.

As shown in FIGS. 1 to 4C, the smart device according to embodiments 1 and 2 of the present invention includes an attachment/detachment part 110 attached to, and detached from the time display unit 10 such that the housing 100 is coupled to a wristwatch.

The attachment/detachment part 110 may include an opening 111 formed in the housing 100 such that the time display unit 10 is inserted through the opening 111 in a direction perpendicular to an upper surface of the time display unit 10 to be upwardly exposed.

The opening 111 is a component formed such that the time display unit 10 is inserted through the opening 111 in the direction perpendicular to the upper surface of the time display unit 10 to expose the upper side of the time display unit 10.

More specifically, the opening 111 is formed to correspond to an outer shape of the time display unit 10, which is circular etc., such that the time display unit 10 is inserted through the opening 111 to be upwardly exposed.

The opening 111 may have one or more protruding jaws (not shown) that are formed on an inner circumferential surface of the housing 110 and inwardly protruded that keeps the housing 110 firmly coupled to the time display unit 10, in a state that the time display unit 10 is inserted through the opening 111 and thereby exposed to the upper side.

The display 210 may be located on the attachment/detachment part 110 that is coupled to the time display unit 10.

More specifically, as shown in FIGS. 1 to 2B, the display 210 may be located in front or rear of the time display unit 10 with respect to the time display unit 10, and with respect to the time display unit 10 and the mounting part 20.

Also, as shown in FIGS. 4A to 4C, the display 210 may be located in the front and the rear of the time display unit 10 with respect to the time display unit 10, and with respect to the time display unit 10 and the mounting part 20.

Herein, the housing 100 may be integrally formed with the attachment/detachment part 110.

It is preferred that the housing 100 is formed to have a radius of curvature corresponding to a portion of the mounting part 20, to which the time display unit 10 is coupled, such that the housing 100 is harmonized with the wristwatch in a state that the housing 100 is coupled to the time display unit 10.

As described above, the smart device according to the present invention is configured to be attached to, and detached from a wristwatch, and thus the smart device can be used at the same time while the existing watch is used as it is, and usability of the wristwatch and the smart device may be thereby increased.

As shown in FIGS. 5A and 5B, in a smart device according to embodiment 3 of the present invention, a housing 100 may be integrally formed with a mounting part 20.

More specifically, the smart device itself may constitute the mounting part 20 that is a strap of a wristwatch.

Herein, since the mounting part 20 has a ring shape, it is preferred that a display 210 is formed to have a curved surface.

As described above, in the smart device according to the present invention, utilizing the mounting part as the smart device while keeping the time display unit of the wristwatch as it is, the smart device can be combined with an existing watch, the smart device may also be used at the same time while the existing watch is used as it is, and usability of the wristwatch and the smart device may be thereby increased.

As shown in FIGS. 6A to 7B, in a smart device according to embodiments 4 and 5 of the present invention, a housing 100 may include a cover unit 140 that covers a time display unit 10.

As shown in FIG. 6B, the cover unit 140 is a component that covers the time display unit 10, one end of which is hinge-coupled to an attachment/detachment part 110 by a hinge axis 120, and the other end of which may have a locking jaw 131 formed to be locked with the attachment/detachment part 100 to be thereby fixed thereto.

Herein, a display 210 may be formed on at least any one of a bottom surface and an upper surface of the cover unit 140.

Herein, as shown in FIG. 7A, it is preferred that the cover unit 140 is formed transparently such that a time display unit 10 is exposed to the outside, and the display 210 is installed on the upper surface of the cover unit 140.

As described above, since the smart device according to the present invention is configured to cover the time display unit of the wristwatch, the smart device may be combined with an existing watch, and may also be used at the same time while the existing watch is used as it is, and usability of the wristwatch and the smart device may be thereby increased.

Meanwhile, a solar cell panel for supplying power to a rechargeable battery of a power supply unit 250 may be installed in the housing 100.

1. A smart device detached from and attached to a wristwatch, including a time display unit (10) configured to display time and a mounting part (20) coupled to both ends of the time display unit (10) such that the time display unit (10) is worn on the wrist of a user, the smart device comprising:
a display (210) for displaying information;
a controller (220) controlling the display (210) to display information;
a storage medium unit (230) controlled by the controller (220), and in which data is stored;
a wireless communication unit (240) controlled by the controller (220), and performing wireless communication;
a power supply unit (250) supplying power to the display (210), the controller (220), the storage medium unit (230), and the wireless communication unit (240); and
a housing (100) in which the display (210), the controller (220), the storage medium unit (230), the wireless communication unit (240), and the power supply unit (250) are installed,
wherein the housing (100) includes an attachment/detachment part (110) attached to, and detached from the time display unit (10).

2. The smart device of claim 1, wherein the attachment/detachment part (110) includes an opening (111) formed in the housing (100) such that the time display unit (10) is inserted through the opening (111) in a perpendicular direction to an upper surface of the time display unit (10) to be upwardly exposed.

3. The smart device of claim 1, wherein the display (210) is located on the attachment/detachment part (110) which is coupled to the time display unit (10).

4. The smart device of claim 1, wherein the housing (100) is integrally formed with the attachment/detachment part (110).

5. The smart device of claim 1, wherein the housing (100) includes a cover unit (140) covering the time display unit (10).

6. The smart device of claim 5, wherein the cover unit (140) is formed transparently such that the time display unit (10) is exposed to the outside, and the display (210) is installed on an upper surface of the cover unit (140).

7. The smart device of claim 1, wherein the housing (100) is integrally formed with the mounting part (20).
